(19) United States
(12) Patent Application Publication
(10) Pub. No.: US 2018/0079308 A1
(43) Pub. Date: Mar. 22, 2018

(54) ACCESSORY PLATE FOR ELECTRIC VEHICLE AND METHODS OF CONVERTING AN INTERNAL COMBUSTION ENGINE VEHICLE INTO AN ELECTRIC VEHICLE

(71) Applicant: ADOMANI, INC., Newport Beach, CA (US)

(72) Inventor: Edward Riggs Monfort, Orange, CA (US)

(21) Appl. No.: 15/267,963

(22) Filed: Sep. 16, 2016

(51) Int. Cl. B60L 1/00; B60R 11/00; B60L 11/18; B60K 1/02

(52) U.S. Cl. CPC B60L 1/003; B60R 11/00; B60L 11/18; B60R 2011/0049; B60Y 2200/91; B60Y 2304/076; B60K 1/02

(57) ABSTRACT

A system for converting an internal combustion engine vehicle having an arrangement of vehicle accessories into an electric vehicle. The system includes an accessory plate having a series of openings for coupling the vehicle accessories to the accessory plate. The openings are arranged corresponding to the arrangement of the vehicle accessories in the internal combustion engine vehicle such that the vehicle accessories are supported in the same configuration in the electric vehicle as in the internal combustion engine vehicle.

### FIELD

The present disclosure relates generally to systems and methods for converting an internal combustion engine vehicle into an electric vehicle.

### BACKGROUND

Electric vehicles are increasing in popularity as an alternative to conventional internal combustion engine vehicles because electric vehicles have the promise of reducing global greenhouse gas production and energy costs and increasing reliance on renewable energy sources. However, electric vehicle platforms that are engineered from the ground up are costly compared to conventional internal combustion engine vehicles that utilize a well-established platform.

Converting internal combustion engine vehicles to electric vehicles has the potential to reduce costs, including engineering costs and component costs, because many components of the internal combustion engine vehicle can be reused, including the transmission, the chassis, and the suspension. However, conventional conversion kits do not reuse the same original equipment manufacturer (OEM) vehicle accessories (e.g., alternator, water pump, or power steering pump) or maintain the accessories in the same configuration that they were in the internal combustion engine vehicle. Accordingly, servicing the converted electric vehicle may require the owner to visit mechanics having specialized training to service the converted electric vehicle and/or may require the use of specialized tooling or infrastructure. Such specialized mechanics may be expensive and/or inconvenient to locate. Additionally, customized vehicle accessories designed specifically for the conversion kit may be expensive and difficult to source.

### SUMMARY

The present disclosure is directed to various embodiments of a system for converting an internal combustion engine vehicle having an arrangement of vehicle accessories into an electric vehicle. In one embodiment, the system includes an accessory plate having a series of openings for coupling the vehicle accessories to the accessory plate. The series of openings are arranged corresponding to the arrangement of the vehicle accessories in the internal combustion engine vehicle such that the vehicle accessories are supported in the same configuration in the electric vehicle as in the internal combustion engine vehicle. The accessory plate may have any configuration suitable for supporting the vehicle accessories in the same configuration that the vehicle accessories were supported in the internal combustion engine vehicle. The accessory plate may be substantially flat. The accessory plate may include a series of second openings for coupling a series of pulleys provided in the internal combustion engine vehicle to the substantially flat accessory plate. The series of second openings are arranged to support the plurality of pulleys in the same configuration in the electric vehicle as in the internal combustion engine vehicle. The system may also include at least one standoff or bracket for coupling at least one of the vehicle accessories to the accessory plate. The vehicle accessories may include any original equipment manufacturer (OEM) accessories, such as an alternator, an air conditioning compressor, a water pump, and/or a power steering pump. The system may also include one or more mounting brackets for coupling the substantially flat accessory plate to a frame of the electric vehicle. The one or more mounting brackets are configured to connect to mounting points on the frame used to install an internal combustion engine to the frame. The accessory plate may also include an opening for receiving a portion of a shaft of an electric motor. The shaft is configured to drive a crankshaft pulley and a serpentine belt connecting the vehicle accessories. The system may also include a radial bearing received in the opening for supporting rotation of the shaft.

The present disclosure is also directed to various methods of converting an internal combustion engine vehicle into an electric vehicle. The internal combustion engine vehicle includes an internal combustion engine and a series of vehicle accessories coupled to the internal combustion engine in an arrangement. The method includes removing the internal combustion engine and the series of vehicle accessories, installing an electric motor, installing an accessory plate to the electric motor, and coupling the vehicle accessories to the accessory plate in the arrangement that the vehicle accessories were supported in the internal combustion engine vehicle. The method may also include installing a battery pack. The method may include installing an auxiliary electric motor. The electric motor to which the substantially flat accessory plate is coupled may be a main electric motor or an auxiliary electric motor. Installing the electric motor may include coupling the electric motor with one or more mounting brackets to mounting points on the frame that were used to attach the internal combustion engine to the frame. Installing the electric motor may include connecting a series of electric motors together in series.

The present disclosure is also directed to various embodiments of an electric vehicle converted from an internal combustion engine vehicle. The electric vehicle includes a frame, a series of wheels coupled to the frame, a transmission, a main electric motor, a battery pack coupled to the main electric motor, a series of vehicle accessories, and an accessory plate. The accessory plate supports the series of vehicle accessories in the same configuration that the vehicle accessories were supported in the internal combustion engine vehicle. The electric vehicle may also include a series of pulleys that are supported by the accessory plate in the same configuration that the pulleys were supported in the internal combustion engine vehicle. The electric vehicle may also include an auxiliary electric motor coupled to the series of vehicle accessories. The main electric motor may include a series of electric motors connected in series. The vehicle accessories may include any original equipment manufacturer (OEM) accessories, such as an alternator, an air conditioning compressor, a water pump, and/or a power steering pump. The electric vehicle may also include one or more mounting brackets coupling the main electric motor to the frame. The one or more mounting brackets are configured to connect to mounting points on the frame used to install an internal combustion engine to the frame.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a schematic side view of a converted electric vehicle according to one embodiment of the present disclosure;

FIG. 2 is a partially exploded view of a powertrain of the converted electric vehicle according to one embodiment of the present disclosure;

FIG. 3 is a front view of an accessory assembly of the converted electric vehicle according to one embodiment of the present disclosure; and

FIG. 4 is a flowchart illustrating a method of converting an internal combustion engine to an electric vehicle according to one embodiment of the present disclosure.

### DETAILED DESCRIPTION

The present disclosure is directed to various embodiments of a system and method for converting an internal combustion engine vehicle into an electric vehicle. In conventional internal combustion engine vehicles, various engine accessories (e.g., an air conditioning compressor, a water pump, an alternator, and a power steering pump) are connected to a crankshaft of the internal combustion engine and are driven by a serpentine belt. The serpentine belt is driven by rotation of a crankshaft pulley connected to the crankshaft of the engine. In general, the type and arrangement of the vehicle accessories is unique to the particular type of internal combustion engine vehicle in which the accessories are provided. The system according to one or more embodiments of the present disclosure includes an accessory plate configured to support the vehicle accessories and connect the vehicle accessories to an electric motor configured to drive the accessories. The accessory plate is configured to support the vehicle accessories in the converted electric vehicle in the same arrangement (i.e., the same position and the same orientation) that the vehicle accessories were supported the internal combustion engine vehicle. The accessory plate is also configured to support the same original equipment manufacturer (OEM) vehicle accessories that were provided in the internal combustion engine vehicle. Supporting the same OEM accessories in the same configuration enables mechanics to service the converted electric vehicle in the same manner they would service the internal combustion vehicle without any additional training or specialized tools or infrastructure (i.e., supporting the OEM vehicle accessories in the same arrangement enables easy replacement, repair, and maintenance of the accessories). Additionally, particular makes and models of internal combustion engine vehicles are associated with specific OEM accessories and therefore incorporating these OEM accessories into the converted electric vehicle allows for easy ordering of replacement parts using the same OEM part numbering system or protocol used to order replacement parts for the internal combustion engine vehicle (i.e., incorporating the OEM accessories of the internal combustion engine into the converted electric vehicle allows consumers to purchase the same replacement OEM accessories that they would have purchased for the internal combustion engine vehicle).

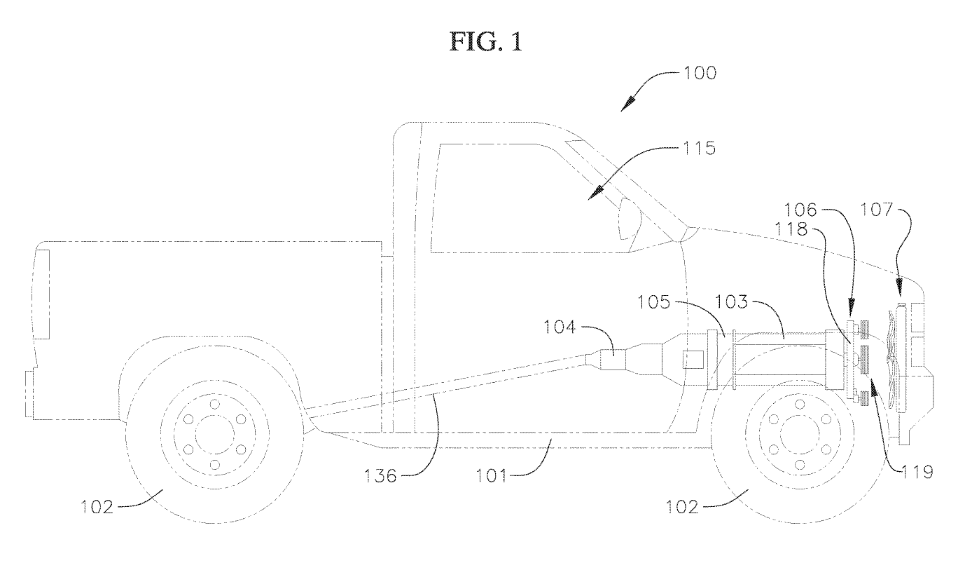

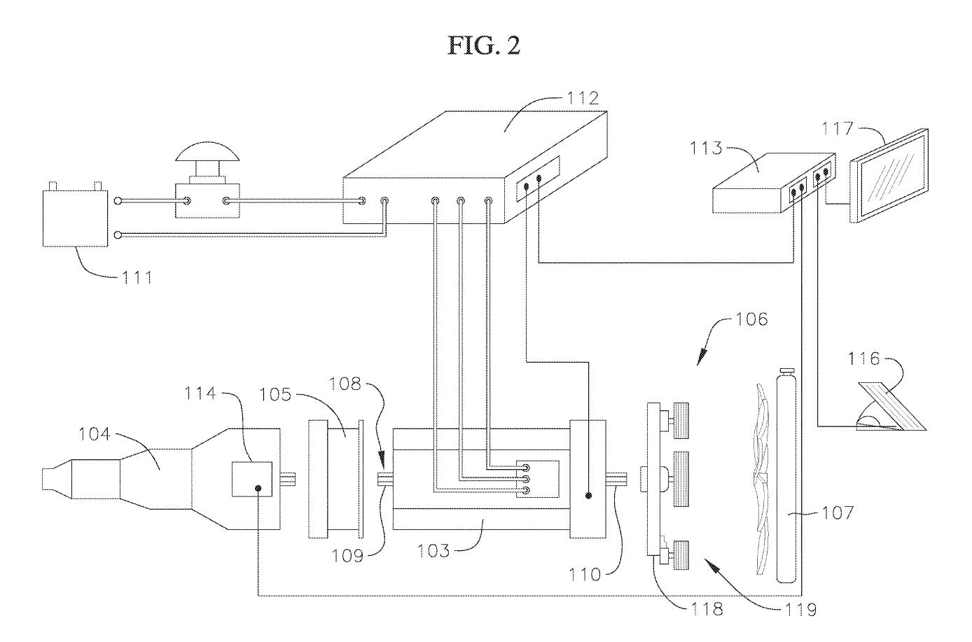

With reference now to FIGS. 1-2, an electric vehicle 100 converted from an internal combustion engine vehicle according to one embodiment of the present disclosure includes a frame (i.e., a chassis) 101, a plurality of wheels 102 coupled to the frame 101, a main electric motor 103 coupled to the frame 101, a transmission 104 connected to a driveshaft 136 configured to deliver power from the main electric motor 103 to one or more of the wheels 102, a torque converter 105 between the transmission 104 and the main electric motor 103, an accessory assembly 106, and a radiator 107. In the illustrated embodiment, the main electric motor 103 includes a shaft 108 having a rear end 109 coupled to the torque converter 105 and a front end 110 coupled to the accessory assembly 106. In the illustrated embodiment, the converted electric vehicle 100 also includes a battery pack 111 for powering the main electric motor 103, a motor controller 112 (e.g., an AC motor controller available from SEVCON™) electrically coupled to the battery pack 111 and the main electric motor 103, and a supervisor box 113 electrically coupled to the motor controller 112 and a transmission control module 114 on the transmission 104. In the illustrated embodiment, the converted electric vehicle 100 also includes operator control region 115 (i.e., a cabin) containing various controls and systems for operating and monitoring various systems of the converted electric vehicle 100, including a throttle 116 and a display screen 117. In one or more embodiments, the throttle 116 is the same OEM throttle provided in the internal combustion engine vehicle.

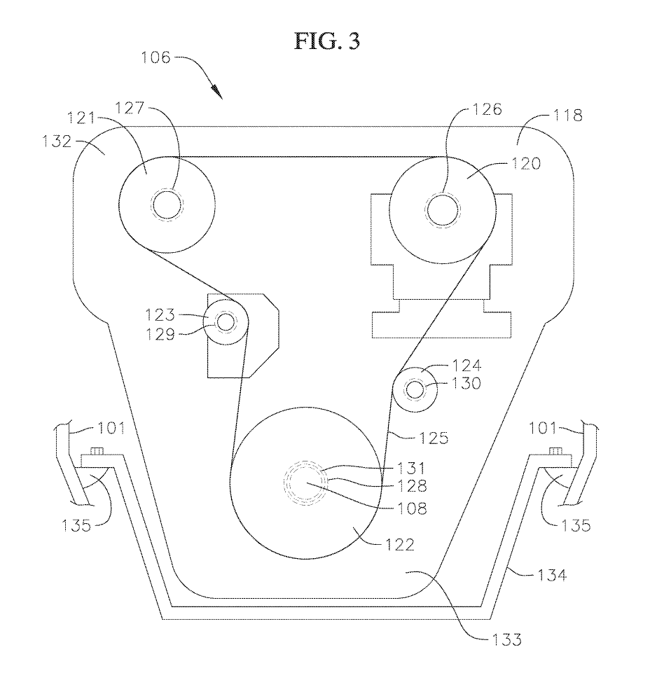

With reference now to FIG. 3, the accessory assembly 106 according to one embodiment of the present disclosure includes an accessory plate 118 supporting various original equipment manufacturer (OEM) vehicle accessories 119 (e.g., an A/C compressor, a water pump, an alternator, and/or a power steering pump) that were provided in the internal combustion engine vehicle. In the illustrated embodiment, the accessory plate 118 couples the OEM vehicle accessories 119 to a front end of the main electric motor 103. In the illustrated embodiment, the OEM vehicle accessories 119 supported by the accessory plate 118 include an OEM alternator 120 and an OEM water pump 121. In one or more embodiments, the accessory assembly 106 may be configured to support any other suitable vehicle accessories depending on the OEM vehicle accessories that were provided in the internal combustion engine vehicle, such as, for example, an OEM air conditioner compressor and/or an OEM power steering pump. In the illustrated embodiment, the accessory plate 118 also supports a crankshaft pulley 122 configured to be connected to the shaft 108 of the main electric motor 103, an OEM tensioner pulley 123, and an OEM idler pulley 124. The accessory plate 118 also supports an OEM serpentine belt 125 extending around the crankshaft pulley 122 and the pulleys of the OEM alternator 120 and an OEM water pump 121.

The accessory plate 118 defines a series of openings 126-130 to support and receive portions of the OEM vehicle accessories 119 (e.g., the OEM alternator 120 and the OEM water pump 121) and the OEM pulleys 122, 123, 124, respectively. The openings 126-130 defined in the accessory plate 118 are arranged (i.e., positioned) such that when the OEM vehicle accessories 119 and the OEM pulleys 122, 123, 124 are coupled to the accessory plate 118 and the accessory plate 118 is coupled to the main electric motor 103 in the converted electric vehicle 100, the OEM vehicle accessories 119 and the OEM pulleys 122, 123, 124 are supported in the same arrangement that the OEM vehicle accessories 119 and the OEM pulleys 122, 123, 124 were supported in the internal combustion engine that was converted into the electric vehicle 100. For example, in one or more embodiments, there may be a centerline-to-centerline alignment between the position of the OEM vehicle accessories 119 and the OEM pulleys 122, 123, 124 in the converted electric vehicle and the position that the OEM vehicle accessories 119 and the OEM pulleys 122, 123, 124 were in in the internal combustion engine vehicle. In one or more embodiments, the OEM vehicle accessories 119 and the pulleys 122, 123, 124 in the converted electric vehicle 100 may have the same relative alignment and spacing that the OEM vehicle accessories 119 and the OEM pulleys 122, 123, 124 had in the internal combustion engine vehicle, but they may not have the same absolute position (e.g., the position of the OEM vehicle accessories 119 and the pulleys 122, 123, 124 in the converted electric vehicle 100 may be collectively shifted upward, downward, forward, or rearward with respect to the position of the OEM vehicle accessories 119 and the OEM pulleys 122, 123, 124 in the internal combustion engine vehicle). Supporting the OEM vehicle accessories 119 and the OEM pulleys 122, 123, 124 in the converted electric vehicle 100 in the same configuration that the OEM vehicle accessories 119 and the OEM pulleys 122, 123, 124 were supported in the internal combustion engine vehicle enables mechanics to service the converted electric vehicle 100 in the same manner they would service the internal combustion vehicle without any additional training or specialized tools or infrastructure. Additionally, providing the OEM vehicle accessories 119 and the OEM pulleys 122, 123, 124 in the same configuration permits the use of the same OEM serpentine belt 125 that was provided in the internal combustion engine vehicle to drive the OEM vehicle accessories 119. Although in the illustrated embodiment the accessory plate 118 is substantially flat (i.e., substantially planar), in one or more embodiments, the accessory plate 118 may have any other configuration (e.g., a non-planar shape) suitable for supporting the OEM vehicle accessories 119 and the OEM pulleys 122, 123, 124 in the same configuration as in the internal combustion engine vehicle.

In the illustrated embodiment, the opening 128 in the accessory plate 118 for the crankshaft pulley 122 is configured to receive the shaft 108 of the main electric motor 103. Additionally, in the illustrated embodiment, a radial bearing 131 is received in the opening 128 to support rotation of the shaft 108 of the main electric motor 103. When the accessory assembly 106 is connected to the front end of the main electric motor 103, the shaft 108 of the main electric motor 103 extends through the opening 128 in the accessory plate 118 and through the radial bearing 131 and is connected to the crankshaft pulley 122.

In the illustrated embodiment, the accessory plate 118 tapers between a wider upper portion 132 and a narrower lower portion 133. In one or more embodiments, the accessory plate 118 may have any other suitable shape depending on the arrangement of the OEM vehicle accessories 119 and the OEM pulleys 122, 123, 124 in the internal combustion engine.

Additionally, in one or more embodiments, the accessory assembly 106 may have one or more brackets or standoffs coupling one or more of the OEM vehicle accessories 119 and/or one or more of the OEM pulleys 122, 123, 124 to the accessory plate 118 in order to maintain the OEM vehicles accessories 119 and the pulleys 122, 123, 124 in the same configuration that the OEM vehicle accessories 119 and the OEM pulleys 122, 123, 124 were arranged in the internal combustion engine vehicle.

Although in the illustrated embodiment the main electric motor 103 is coupled to the accessory assembly 106 such that the main electric motor 103 drives the OEM vehicle accessories 119, in one or more embodiments, the converted electric vehicle 100 may include a separate auxiliary electric motor for driving the OEM vehicle accessories 119. In one or more embodiments, the auxiliary electric motor may be configured to drive the OEM vehicle accessories 119 when the main electric motor 103 is not operating (e.g., when the electric vehicle 100 is stopped) and the main electric motor 103 may be configured to drive the OEM vehicle accessories 119 when the main electric motor 103 is running (e.g., when the electric vehicle is travelling). In one or more embodiments, the electric vehicle 100 may include a clutch between the main electric motor 103 and the auxiliary electric motor that may be disengaged to permit the main electric motor 103 to operate the OEM vehicle accessories 119 when the main electric motor 103 is driving the electric vehicle 100. In one or more embodiments, the OEM vehicle accessories 119 may be driven only by the auxiliary electric motor (i.e., the converted electric vehicle 100 may include a dedicated auxiliary electric motor for driving the OEM vehicle accessories 119). In one or more embodiments, the auxiliary electric motor may be positioned between the main electric motor 103 and the accessory assembly 106, although in one or more embodiments, the auxiliary electric motor may be positioned in any other suitable location (e.g., the auxiliary electric motor may be positioned in front of the accessory assembly 106 such that the accessory assembly 106 is disposed between the main electric motor 103 and the auxiliary electric motor). Providing a separate auxiliary motor for driving the OEM vehicle accessories 119 enables the OEM vehicle accessories 119 to continue to operate when the converted electric vehicle 100 is stopped and the main electric motor 103 is not running (e.g., when the converted electric vehicle 100 is parked or at a stop light).

Additionally, in one or more embodiments, the motor controller 112 may be configured to operate the auxiliary electric motor such that the auxiliary electric motor matches or substantially matches the revolutions per minute (RPMs) of the idling internal combustion engine that was originally provided in the converted electric vehicle 100. For instance, the motor controller 112 may be configured to operate the auxiliary motor and the OEM vehicle accessories 119 from approximately 600 RPMs to approximately 1,000 RPMs (e.g., approximately 800 RPMs) when the converted electric vehicle 100 is stopped. Additionally, in one or more embodiments, the motor controller 112 may be configured to limit the maximum RPMs of the OEM vehicle accessories 119 (e.g., a maximum from approximately 5,000 RPMs to approximately 7,000 RPMs, such as approximately 6,000 RPMs) even when the output of the main electric motor 103 exceeds this limit. In one or more embodiments, the motor controller 112, which is electrically connected to the transmission control module 114 on the transmission 104, is configured to change gears at the same RPMs at which the transmission changed gears in the internal combustion engine vehicle (i.e., the motor controller 112 is configured to match the maximum RPMs before changing gears of the internal combustion engine vehicle). For example, if the transmission in the internal combustion engine vehicle was configured to change from first gear to second gear when the internal combustion engine reached approximately 2,800 RPMs, then the motor controller 112 in the converted electric vehicle 100 will be configured to change the transmission 104 from first gear to second gear when the main electric motor 103 reaches approximately 2,800 RPMs. In this manner, the converted electric vehicle 100 may be configured to replicate (i.e., match) the RPM idle points and the maximum RPM before changing gears of the internal combustion engine vehicle such that the OEM vehicle accessories 119 operate under the same conditions (e.g., the same dynamic loads) as they did in the internal combustion engine vehicle. In one or more embodiments in which the converted electric vehicle 100 includes a separate auxiliary electric motor for driving the OEM vehicle accessories 119, the converted electric vehicle 100 may include a separate controller (e.g., an auxiliary motor controller) for controlling the auxiliary electric motor (e.g., the converted electric vehicle 100 may include the motor controller 112 for operating the main electric motor 103 and a separate controller for operating the auxiliary electric motor).

Although in the illustrated embodiment the main electric motor 103 is a single motor, in one or more embodiments, the main electric motor 103 may include two or more electric motors. For instance, in one or more embodiments, the main electric motor 103 may include two or more electric motors connected in series (i.e., the main electric motor 103 may utilize motor stacking). Stacking the electric motors in series increases the power of the main electric motor 103 compared to a single electric motor. In one or more embodiments in which the main electric motor 103 includes two or more stacked electric motors, one or more of the electric motors may include a through shaft that permits the shafts of adjacent electric motors to be coupled together in series. The number and size of the electric motors may be selected depending on the desired power output of the main electric motor 103 and the intended application of the converted electric vehicle 100.

In the illustrated embodiment, the converted electric vehicle 100 also includes one or more mounting brackets 134 for attaching the accessory assembly 106 and the main electric motor 103 to the frame 101 of the vehicle 100. In one or more embodiments, the one or more mounting brackets 134 may be configured to use the same mounting points 135 (e.g., the same OEM mounting studs and/or OEM rubber engine mounts) that were used to mount the internal combustion engine to the frame 101 of the vehicle. Using the same mounting points 135 permits the main electric motor 103, the OEM vehicle accessories 119, and the auxiliary electric motor, if provided, to be mounted to the frame 101 of the vehicle 100 in the exact same manner that the internal combustion engine was mounted to the frame 101. Otherwise, customized installation of the main electrical motor 103 would require specialized training for a technician and/or specialized tools and equipment, which would be costly and time-consuming. Additionally, using the same mounting points 135 on the frame 101 allows the main electric motor 103 to be installed without having to modify the frame 101 of the vehicle 100 (e.g., without having to drill additional holes in the frame 101), which could weaken the structural integrity of the frame 101 and necessitate that the converted electric vehicle 100 be reevaluated for crashworthiness and/or other department of transportation (DOT) approvals. The one or more mounting brackets 134 may have any configuration (e.g., shape and size) suitable for the configuration of the main electric motor 103, the accessory assembly 106, and the frame 101 of the vehicle 100. For instance, in one or more embodiments, the one or more mounting brackets 134 may have a saddle or U-shaped configuration. Suitable mounting brackets are described in U.S. Pat. No. 9,102,221, the entire contents of which are incorporated herein by reference.

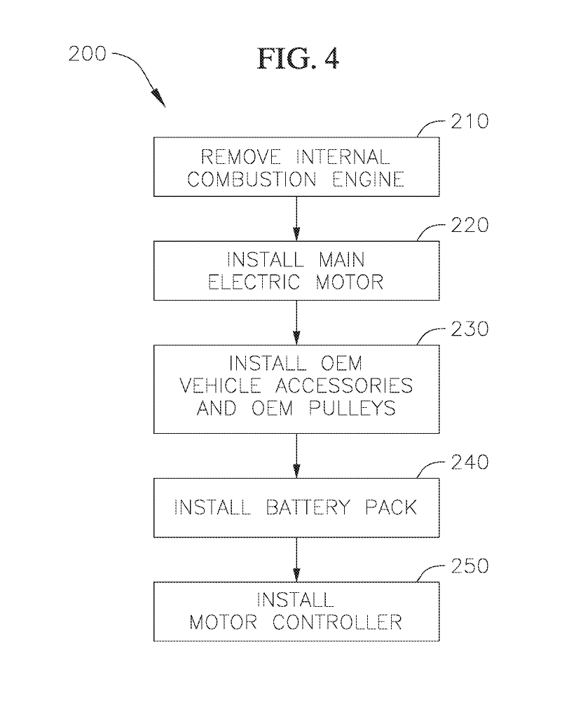

FIG. 4 depicts a method 200 of converting an internal combustion engine vehicle into an electric vehicle according to one embodiment of the present disclosure. The internal combustion engine vehicle includes a frame, a transmission, an internal combustion engine coupled to the frame and the transmission, a series of OEM vehicle accessories (e.g., an air conditioning compressor, a water pump, an alternator, and a power steering pump) coupled to the internal combustion engine, a series of OEM pulleys (e.g., an OEM drive pulley, an OEM tensioner pulley, and an OEM idler pulley), an OEM serpentine belt extending around the OEM vehicle accessories, and an OEM radiator. In the internal combustion engine, the OEM vehicle accessories are arranged in a particular configuration specific to the make and model of the internal combustion engine vehicle.

In the illustrated embodiment, the method 200 includes a task 210 of removing the internal combustion engine from the vehicle. In one or more embodiments, the method 200 may also include one or more tasks of removing equipment or components from the vehicle that is necessary for the operation of the internal combustion engine vehicle, but unnecessary for the operation of the converted electric vehicle, such as an exhaust system, a gas tank, and gas lines. The method 200 also includes a task 220 of installing a main electric motor in the vehicle. In one embodiment, the task 220 of installing the main electric motor includes coupling the main electric motor to the drive shaft, the transmission, and the torque converter with an adapter plate. Additionally, the task 220 of installing the main electric motor in the vehicle may include coupling the main electric motor to the frame of the vehicle with one or more mounting brackets. The one or more mounting brackets may be configured to be coupled to OEM mounting points on the frame (e.g., OEM rubber engine mounts or OEM mounting studs), which preserves the structural integrity of the frame. Additionally, in one or more embodiments, the task 220 of installing the main electric may include connecting two or more electric motors together in series (i.e., stacking electric motor) and installing the electric motor stack in the vehicle.

In the illustrated embodiment, the method 200 of converting the internal combustion engine vehicle also includes a task 230 of installing the OEM vehicle accessories (e.g., the air conditioning compressor, the water pump, the alternator, and the power steering pump) and the OEM pulleys (e.g., an OEM drive pulley, an OEM tensioner pulley, and an OEM idler pulley). The task 230 of installing the OEM vehicle accessories and the OEM pulleys includes coupling the OEM vehicle accessories and the OEM pulleys to an accessory plate (e.g., a substantially flat plate or a non-planar plate) to form an accessory assembly, and installing the accessory assembly in the vehicle. In one or more embodiments, one or more of the OEM vehicle accessories and/or one or more of the OEM pulleys may be coupled to the accessory plate with a bracket and/or a standoff. The accessory plate defines a series of openings positioned to receive and support the OEM vehicle accessories and the OEM pulleys in the same arrangement (i.e., the same position and orientation) that the OEM vehicle accessories and the OEM pulleys were arranged in the internal combustion engine vehicle. Accordingly, following the task 230 of coupling the OEM vehicle accessories and the OEM pulleys to the accessory plate and installing the accessory assembly in the vehicle, the OEM vehicle accessories and the OEM pulleys will be supported in the same arrangement (i.e., the same position and orientation) in the converted electric vehicle that the OEM vehicle accessories and the OEM pulleys were arranged in the internal combustion engine vehicle. As described above, supporting the OEM vehicle accessories and the OEM pulleys in the converted electric vehicle in the same configuration that the OEM vehicle accessories and the OEM pulleys were supported in the internal combustion engine vehicle enables mechanics to service the converted electric vehicle in the same manner they would service the internal combustion vehicle without any additional training or specialized tools or infrastructure and enables customers to purchase the same replacement OEM accessories that they would purchase for the internal combustion engine vehicle.

Additionally, in one or more embodiments, the task 230 of installing the OEM vehicle accessories and the OEM pulleys includes coupling the accessory assembly to a front end of the main electric motor such that the shaft of the main electric motor is configured to operate the OEM vehicle accessories. In one or more alternate embodiments, the task 230 may include coupling the accessory assembly to an auxiliary electric motor configured to operate the OEM vehicle accessories. Accordingly, in one or more embodiments, the method 200 of converting the internal combustion engine vehicle may include a task of installing an auxiliary electric motor. The auxiliary electric motor may be installed in any suitable position within the vehicle, such as, for example, between the main electric motor and the accessory assembly or in front of the accessory assembly such that the accessory assembly is disposed between the main electric motor and the auxiliary electric motor. When the accessory assembly is coupled to the main electric motor or the auxiliary electric motor, a shaft of the main electric motor or the auxiliary electric motor extends through an opening in the accessory plate and is coupled to the crankshaft pulley on the accessory plate. Accordingly, when the main electric motor or the auxiliary electric motor is operated, the shaft of the main electric motor or the auxiliary electric motor rotates the crankshaft pulley, which drives the serpentine belt and operates the OEM vehicle accessories. As described above, providing an auxiliary electric motor allows the OEM vehicle accessories to be operated independently of the main electric motor. For example, the auxiliary electric motor allows the OEM vehicle accessories to be operated when the main electric motor is not running (e.g., when the electric vehicle is parked or at a stop light).

In one or more embodiments, the task 230 of installing the OEM vehicle accessories may include coupling the accessory assembly to the main electric motor or the auxiliary electric motor before or after the main electric motor and/or the auxiliary electric motor are installed in the converted electric vehicle.

In the illustrated embodiment, the method 200 of converting the internal combustion engine vehicle also includes a task 240 of installing a battery pack and electrically coupling the battery pack to the main electric motor. In one or more embodiments in which the method 200 includes a task of installing an auxiliary electric motor to operate the OEM vehicle accessories, the task 240 of installing the battery pack includes electrically coupling the battery pack to the auxiliary electric motor. Additionally, in the illustrated embodiment, the method 200 includes a task 250 of installing a motor controller. The task 250 of installing the motor controller includes electrically coupling the motor controller to the battery pack and the main electric motor. The task of installing the motor controller may also include a task of installing a supervisor box and electrically connecting it to the motor controller and a transmission control module on the transmission. Additionally, in one or more embodiments, the method 200 of converting the internal combustion engine vehicle may include using the same OEM hoses, air lines, brake lines, and electrical harnesses that were provided in the internal combustion engine vehicle in the converted electric vehicle.

The tasks described above for converting an internal combustion engine vehicle into an electric vehicle may be performed in the order described or in any other suitable sequence. Additionally, the method described above is not limited to the tasks described. Instead, one or more of the tasks described above may be absent and/or one or more additional tasks may be performed.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Additionally, although relative terms such as “front,” “rear,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween.

1. A system for converting an internal combustion engine vehicle having an arrangement of vehicle accessories into an electric vehicle, the system comprising:
an accessory plate having a plurality of openings for coupling the vehicle accessories to the accessory plate, wherein the plurality of openings are arranged corresponding to the arrangement of the vehicle accessories in the internal combustion engine vehicle such that the vehicle accessories are supported in the same configuration in the electric vehicle as in the internal combustion engine vehicle.

2. The system of claim 1, wherein the accessory plate is substantially flat.

3. The system of claim 1, wherein the accessory plate further includes a plurality of second openings for coupling a plurality of pulleys provided in the internal combustion engine vehicle to the accessory plate, the plurality of second openings being arranged to support the plurality of pulleys in the same configuration in the electric vehicle as in the internal combustion engine vehicle.

4. The system of claim 1, further comprising at least one standoff or bracket for coupling at least one of the vehicle accessories to the accessory plate.

5. The system of claim 1, wherein the vehicle accessories are selected from the group of original equipment manufacturer accessories consisting of an alternator, an air conditioning compressor, a water pump, and a power steering pump.

6. The system of claim 1, wherein the system further comprises one or more mounting brackets for coupling the accessory plate to a frame of the electric vehicle, the one or more mounting brackets being configured to connect to mounting points on the frame used to install an internal combustion engine to the frame.

7. The system of claim 1, wherein the accessory plate further comprises an opening for receiving a portion of a shaft of an electric motor, the shaft configured to drive a crankshaft pulley and a serpentine belt connecting the vehicle accessories.

8. The system of claim 7, further comprising a radial bearing received in the opening for supporting rotation of the shaft.

9. A method of converting an internal combustion engine vehicle into an electric vehicle, the internal combustion engine vehicle having an internal combustion engine and a plurality of vehicle accessories coupled to the internal combustion engine in an arrangement, the method comprising:
removing the internal combustion engine and the plurality of vehicle accessories;
installing an electric motor;
installing an accessory plate to the electric motor; and
coupling the vehicle accessories to the accessory plate in the arrangement that the vehicle accessories were supported in the internal combustion engine vehicle.

10. The method of claim 9, further comprising installing a battery pack.

11. The method of claim 9, further comprising installing an auxiliary electric motor.

12. The method of claim 9, wherein the electric motor is a main electric motor or an auxiliary electric motor.

13. The method of claim 9, wherein the installing the electric motor comprises coupling the electric motor with one or more mounting brackets to mounting points on the frame that were used to attach the internal combustion engine to the frame.

14. The method of claim 9, wherein the installing the electric motor comprises connecting a plurality of electric motors together in series.

15. An electric vehicle converted from an internal combustion engine vehicle, the electric vehicle comprising:
a frame;
a plurality of wheels coupled to the frame;
a transmission;
a main electric motor;
a battery pack coupled to the main electric motor;
a plurality of vehicle accessories; and
an accessory plate supporting the plurality of vehicle accessories in the same configuration as the vehicle accessories were supported in the internal combustion engine vehicle.

16. The electric vehicle of claim 15, further comprising a plurality of pulleys, wherein the accessory plate supports the plurality of pulleys in the same configuration that the plurality of pulleys were supported in the internal combustion engine vehicle.

17. The electric vehicle of claim 15, further comprising an auxiliary electric motor coupled to the plurality of vehicle accessories.

18. The electric vehicle of claim 15, wherein the main electric motor comprises a plurality of electric motors connected in series.

19. The electric vehicle of claim 15, wherein the vehicle accessories are selected from the group of original equipment manufacturer accessories consisting of an alternator, an air conditioning compressor, a water pump, and a power steering pump.

20. The electric vehicle of claim 15, further comprising one or more mounting brackets coupling the main electric motor to the frame, the one or more mounting brackets configured to connect to mounting points on the frame used to install an internal combustion engine to the frame.
